(19) United States
(12) Patent Application Publication
(10) Pub. No.: US 2004/0205532 A1
(43) Pub. Date: Oct. 14, 2004

(54) Computerized method and system for obtaining and processing a message for improving a product or a work routine

(75) Inventor: Theresia Lindner, Seligenporten (DE)

Correspondence Address: SCHIFF HARDIN, LLP, PATENT DEPARTMENT, 6600 SEARS TOWER, CHICAGO, IL, 60606-6473, US

(73) Assignee: Siemens Aktiengesellschaft

(21) Appl. No.: 10/034,175

(22) Filed: Dec. 20, 2001

(51) Int. Cl. G06F 17/24

(52) U.S. Cl. 715/507

(57) ABSTRACT

In a computerized method and a system for obtaining and processing messages for improving a product or a work routine, at a central database, an electronic form is received which contains a message and information which identifies the product or the work routine for which improvements are suggested. After receiving the electronic form, the database extracts the message from the electronic form and stores it in a table of the central database. The table is associated with the identified product or the identified work routine. The inventive system is comprised of an electronic form and a central databank. The electronic form also can have a submit function. The electronic form can be obtained through a Web page which can be downloaded with a computer connected to the Internet. The electronic form can be filled out by writing a message in the message field and by indicating one of the work routines or one of the products, and, when filled out, can be conveyed to the central database by activating the submit function. The central database stores the message based on the marked work routine or based on the marked product in a table which is related to the marked work routine or to the marked product, respectively.

### BACKGROUND OF THE INVENTION

1. Field of the Invention

The invention relates to a computerized method for obtaining and processing a message for improving a product or a work routine, as well as to a system for obtaining and processing a message for improving a product or a work routine.

2. Description of the Prior Art

A manufacturer often wants to know if its customers are satisfied with its products. For this purpose, the manufacturer may conduct a market survey. The manufacturer can use information obtained during the market survey to improve its products. A market survey is normally conducted during a short time, for a certain product, and is addressed to a limited group of people. Furthermore, such a market survey typically is relatively expensive.

In addition, the manufacturer may obtain feedback from its customers, if the customers address their suggestions to a sales person employed by the manufacturer. Then, the sales person might inform the manufacturer's marketing or product development department, so that the products might be improved for future releases based on the customers' feedback.

Some manufacturers post a web page on the Internet. A person interested in the manufacturer's products might download the web page with a computer connected to the Internet to inform himself or herself, for instance, about current offerings of the manufacturer. The web page is usually designed so that the person can contact the manufacturer in a convenient way. The web page might include a field which, when activated, causes an electronic form to appear on the screen. The electronic form is normally designed so that the person can write and submit a message directly to the manufacturer, so that one of the manufacturer's employees can appropriately reply to the person's inquiry.

Should the message be a suggestion to improve one of the manufacturer's products, then the employee might forward the message to the marketing or product development department. An automated procedure to further process the message is not known at this time.

FIG. 1 depicts an example of such a web page 1 which is assigned to Siemens AG. When a person who had downloaded the web page 1 hits a field 2 named “contact us”, an electronic form 20 appears on the screen of the computer used for downloading the web page 1. The electronic form 20 is shown in FIG. 2. The electronic form 20 has a field 21 in which a message for Siemens AG can be written. The form 20 has a field 22 which asks the person to indicate his or her address, so that an employee of Siemens AG can respond to the message. After the person hits the “send” button 23 of the electronic form 20 the message is conveyed to an e-mail address assigned to Siemens AG. Then, the employee can read the message and provide the person with the requested information.

Besides obtaining a suggestion for a possible improvement of its products, many manufacturers would like to obtain a suggestion for possibly improving the manufacturer's workflow or work routines. An example of a work routine is the procedure of delivering and installing a machine or an apparatus at the customer's location. Another example of a work routine is a vendor delivering parts to the manufacturer.

### SUMMARY OF THE INVENTION

An object of the present invention is to provide a computerized method which supports a structured and automated approach for gathering and processing messages for improving a product or a work routine.

Another object of the invention is to provide a system which can be utilized for gathering and processing suggestions to improve a product or a work routine.

This object is achieved in accordance with the invention in a computerized method for obtaining and processing messages for improving a product, including the steps of receiving, at a central database, an electronic form which has been filled out and which contains a message and information which identifies the product, retrieving the message from the electronic form, and based on the information, storing the message in a table of the central database, the table being related to the product. According to the inventive computerized method, the central database receives the electronic form. The electronic form contains the message and information about the product. Based on the information, the central database stores the extracted message in the table which is related to the product.

For example, assume a customer of the manufacturer writes and submits the message to the manufacturer. Should the manufacturer obtain from several customers several messages about how to improve his/her products, then the manufacturer not only has this information in its possession, but also has this information available in a structured form. This is because each message of each electronic form is stored in a table associated to the product which is named by the electronic form. As a result, the manufacturer can analyze this information in a relatively short time and thus react to its customers' suggestions in a relatively short time. This results in increased customer satisfaction and eventually in an increased profit.

The electronic form to be filled out by the customer is, according to a preferred embodiment of the invention, obtained through a web page. The customer downloads the web page with a computer connected to the Internet. According to the invention, the web page has a link to the central database. When this link is activated, then the electronic form appears on the screen of the computer used for downloading the web page. The electronic form further includes a message field, a list of products, and a submit function. The customer can write his or her message in the message field and mark one of the products of the list of products depending which product he or she wants to comment on. After the customer has filled out the message field and marked the product, the customer submits the filled out electronic form by activating the submit function. The submit function can be realized by hitting an appropriate “submit” button on the electronic form. Since the filled out electronic form contains information about which product relates to the message, the central database can store the extracted message on the appropriate table. Since a web page can be easily accessed, it is advantageous to obtain the electronic form utilizing the World Wide Web.

The product is formed by computer-software in an embodiment of the invention. The computer-software generates the electronic form. The purchaser or user of the software product can fill out the electronic form after the software is configured on a computer. The electronic form has a message field in which the customer can write his or her suggestion to the manufacturer. As soon as the computer is connected to an information network, for example the Internet, the customer submits the filled out electronic form to the central database by activating a submit function. The submit function can be realized by hitting an appropriate “submit” button on the electronic form. An advantage of this embodiment of the invention is that the customer can send a message to the manufacturer easily as soon as he or she installs the product.

In a further embodiment of the computerized method of the invention, after storing the message in the table of the central database, the message is scanned for predefined terms, and according to found terms the message is forwarded to a predefined address. The predefined address can be, according to variants of the invention, related to a marketing department or to a product development department of the manufacturer.

If the message is forwarded to the product development department, then the manufacturer's employees who are in charge of developing and improving products are made aware of submitted suggestions to the central database. Before the message is forwarded to the product development department, the message is scanned for predefined terms. These terms might be related to a certain function or to a certain part of the product. Thus, the employees of the product development department do not receive messages irrelevant to their work. The message can be specifically forwarded to a Change Of Request Tool generally known to persons skilled in the art. Then, employees responsible for product improvement can view the forwarded message and determine if a similar change of request has been already filed and if this change of request has been already considered. Especially if it has already been decided that the suggested improvement will be incorporated in a further version of the product, then the employee can inform the customer who submitted that message that his suggestion has been already considered. Consequently, the customer might purchase the next version as soon as it is available resulting in higher profits for the manufacturer. Should the message include a new suggestion for an improvement and should several customers submit similar suggestions, then the employee can contemplate incorporating this idea in further product releases. This also enhances customer satisfaction and eventually increases the manufacturer's profit.

If the message is forwarded to the marketing department, then the message can be, for example, used for Customer Relation Management (CRT). The message also can be used to analyze new markets or develop a new application for a product which is already marketed. The message also can be used to improve the instruction manual of a certain product if several customers suggest the addition of a function to a product, even though this function is already available. The marketing department also can reward a customer if the customer submits many and particularly valuable suggestions.

The list of products is adaptable to a person who downloads the web page, in a further embodiment of the invention. This version of the invention is especially advantageous if the manufacturer sells many different products. Then, the list of products might only include those products the customer is interested in. For example, if a manufacturer produces a wide range of products such as medical devices, electric drives, automation devices, etc., and the customer is only interested, for instance, in medical devices, then the list of products might only contain medical devices offered by the manufacturer.

In addition, the invention provides a system which generates an electronic form which has a message field, a list of products, and a submit function, and a central databank including tables which are related to the products. The electronic form can be obtained through a web page which can be downloaded with a computer connected to the Internet. Moreover, the electronic form can be filled out by writing a message in the message field and by marking one of the products of the list of products. After the electronic form is filled out, it is conveyed to the central database by activating the submit function. Then, the central database extracts and stores the message, based on which product was marked, on the relevant table. Thus, the inventive system is designed to be used to carry out the inventive computerized method.

The invention also provides a computerized method for obtaining and processing a message for improving a work routine comprising the steps of receiving, at a central database, an electronic form which has been filled so that it comprises a message related to the work routine and information which identifies the work routine, retrieving the message from the electronic form, and, based on this information, storing the message on a table in the central database, specifically the table which is related to the work routine.

Additionally, the invention provides a system which generates an electronic form having a message field, a list of work routines, a submit function, and a central databank including tables which are related to the work routines. The electronic form can be obtained through a web page which can be downloaded with a computer connected to the Internet; the electronic form can be filled out by writing a message in the message field and by marking one of the work routines of the list of work routines. The filled out electronic form is conveyed to the central database by activating the submit function. The central database stores the message based on the marked work routine in a relevant table.

An advantage of the invention is that it provides a convenient way for a person to submit a suggestion to the manufacturer. Otherwise such a person may be less likely to submit it at all. Another advantage of the invention is that the manufacturer can obtain more suggestions for improving his/her products or work routines. Furthermore, the invention provides a convenient way to process this information. Consequently, the manufacturer can increase his/her market share, customer satisfaction, and profit.

### BRIEF DESCRIPTION OF THE DRAWINGS

FIG. 1 shows a conventional web page.

FIG. 2 shows a conventional electronic form which can be used to contact a manufacturer.

FIG. 3 shows a scenario illustrating the invention.

FIG. 4 shows another web page for use in the inventive method and system.

FIG. 5 shows an electronic form which is used for the invention.

FIG. 6 shows a flow chart illustrating the inventive computerized method.

FIG. 7 shows another electronic form which is used for the invention.

FIG. 8 shows another flow chart illustrating the inventive computerized method.

### DESCRIPTION OF THE PREFERRED EMBODIMENTS

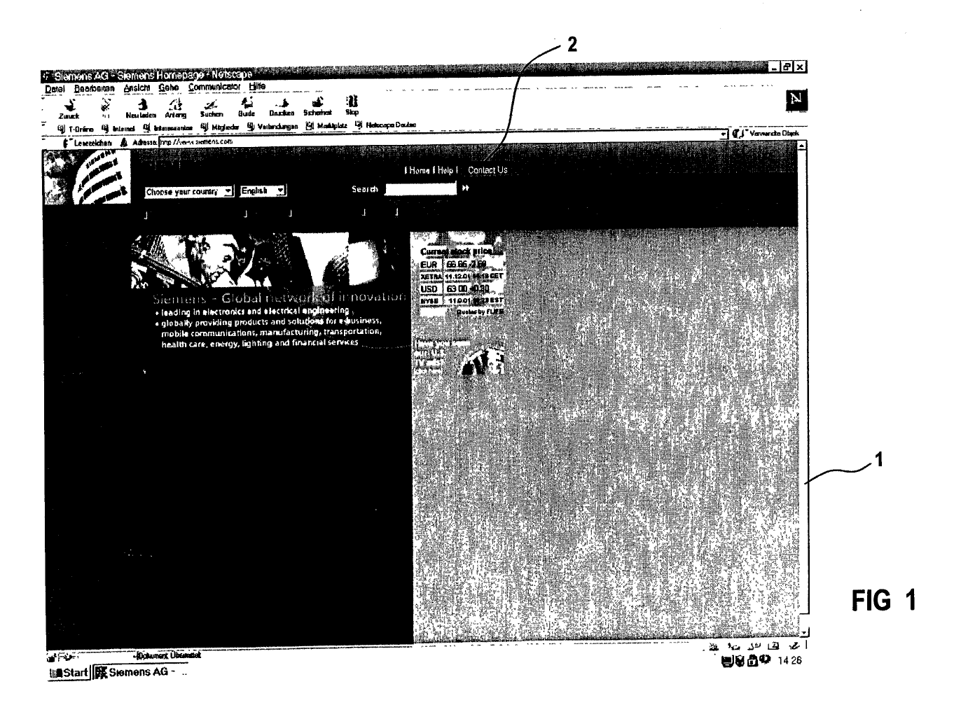

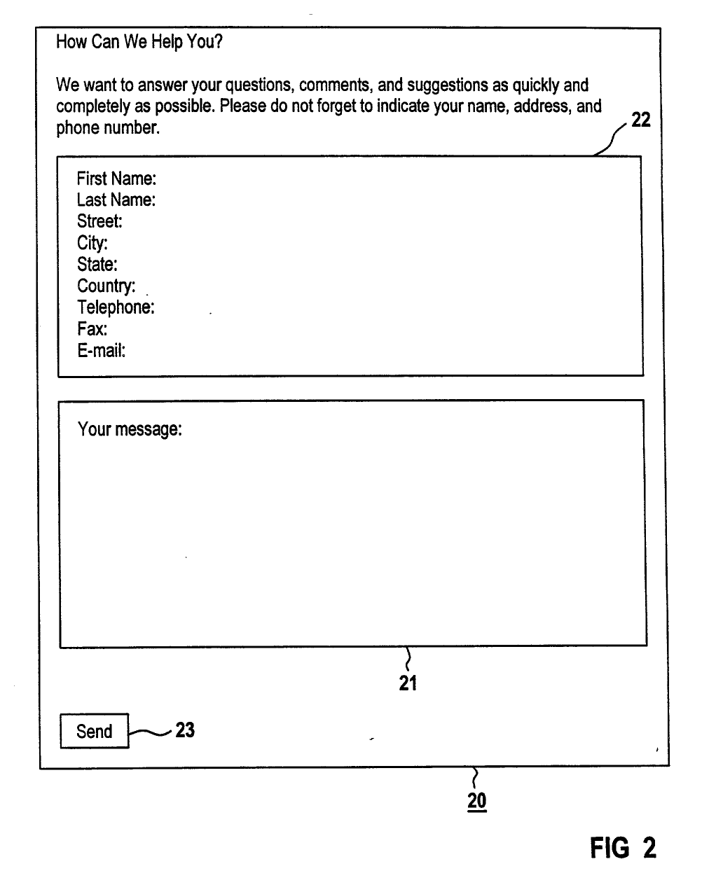

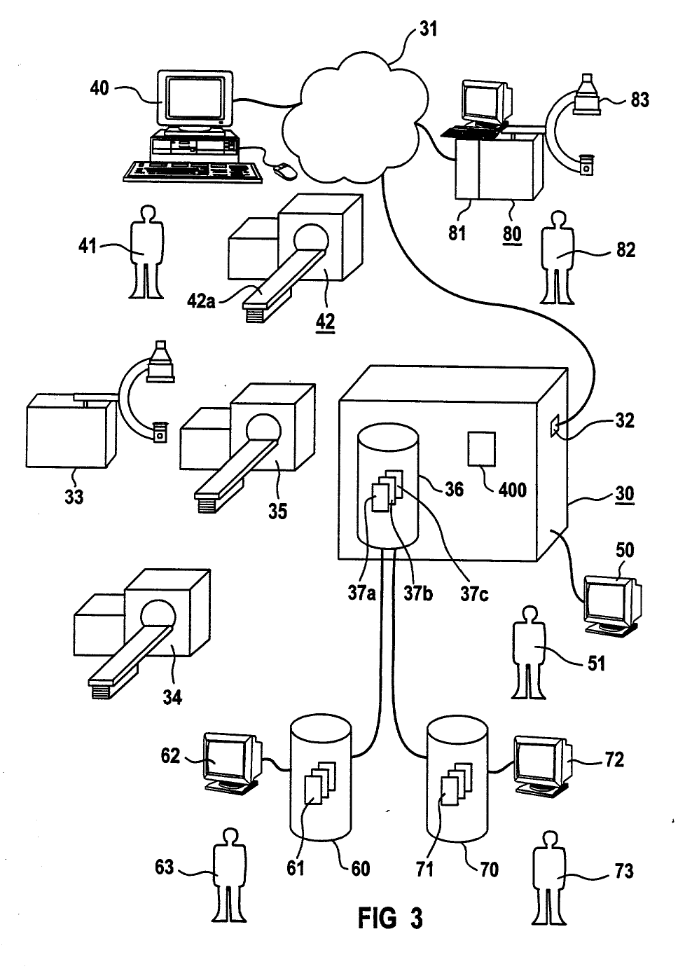

FIGS. 1 and 2 have been described in the introduction. FIG. 3 depicts a scenario which illustrates the invention. FIG. 3 shows a computer-server 30 which is connected to the Internet 31 with a connector 32. The computer-server 30 is operated by a manufacturer of medical apparatuses. An X-ray apparatus 33, a computed tomography apparatus 34, and a magnetic resonance apparatus 35, as a selection of the many medical apparatuses produced by the manufacturer, are shown as examples in FIG. 3. The computer-server 30 further has a database 36, containing several tables 37a to 37c. Each of the tables 37a to 37c is associated with a specific type of medical apparatus produced by the manufacturer. For this example, table 37a is associated with the X-ray apparatus 33, table 37b is associated with the computed tomography apparatus 34, and table 37c is associated with the magnetic resonance apparatus 35.

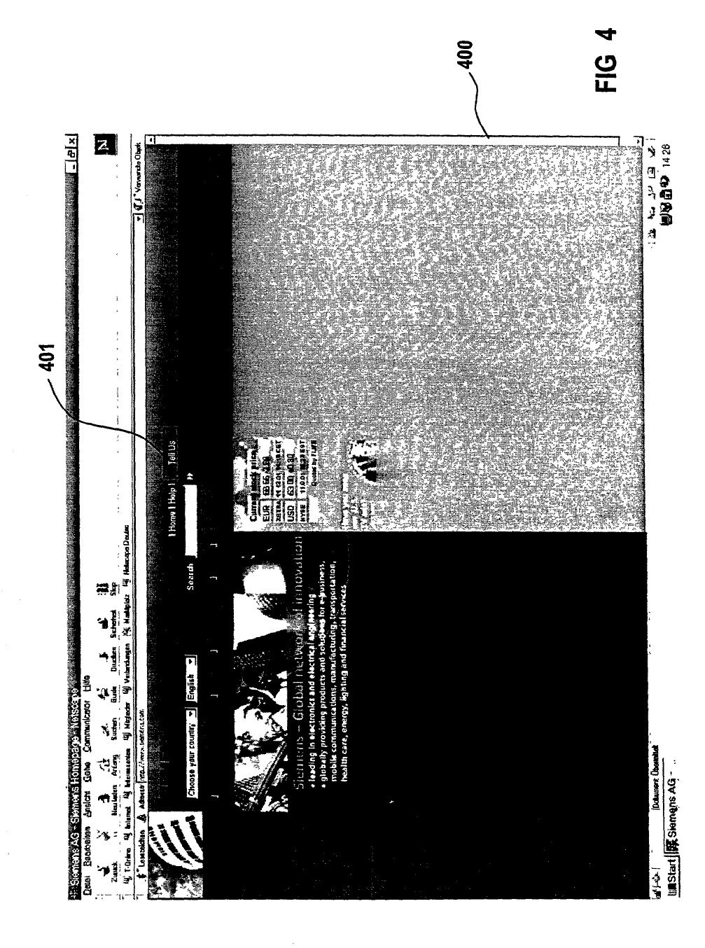

In addition, a web page 400 which is shown in greater detail in FIG. 4 is stored on the computer-server 30. The web page 400 is assigned to the manufacturer and can be downloaded with computers connected to the Internet 31 as is commonly known in the art.

FIG. 3 shows, as an example, a standard PC (personal computer) 40 which is connected to the Internet 31. The PC 40 is operated by a customer 41 who purchased a magnetic resonance apparatus 42 from the manufacturer.

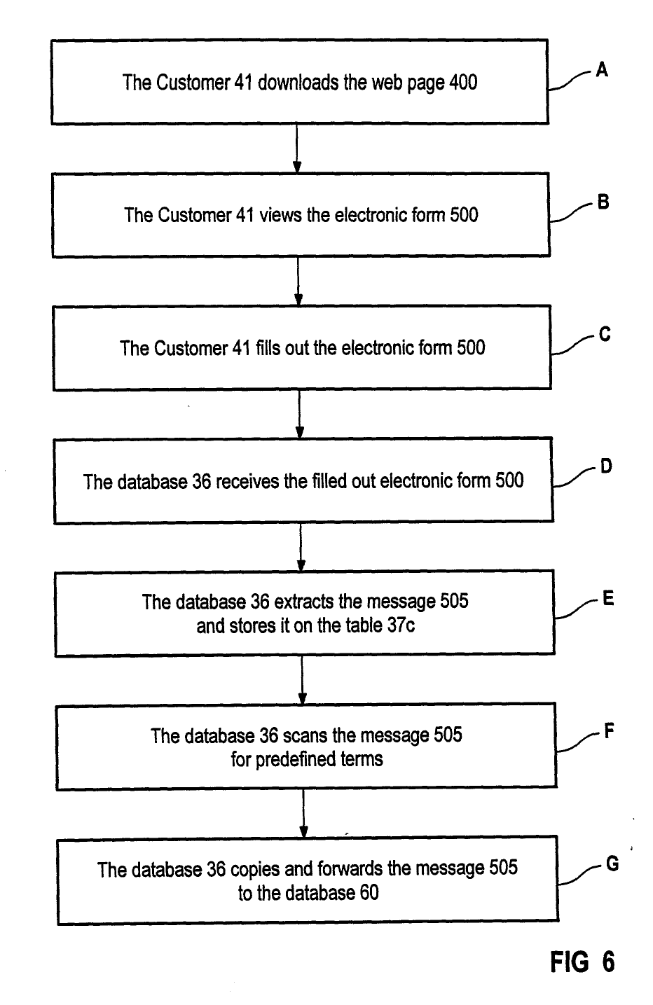

In the present example, the customer 41 downloads the web page 400 from the computer-server 36 with his computer 40 using a browser which is stored on the computer 40. After downloading the web page 400 the customer 41 views the web page 400 on the screen of his computer 40 (step A of the flow chart of FIG. 6).

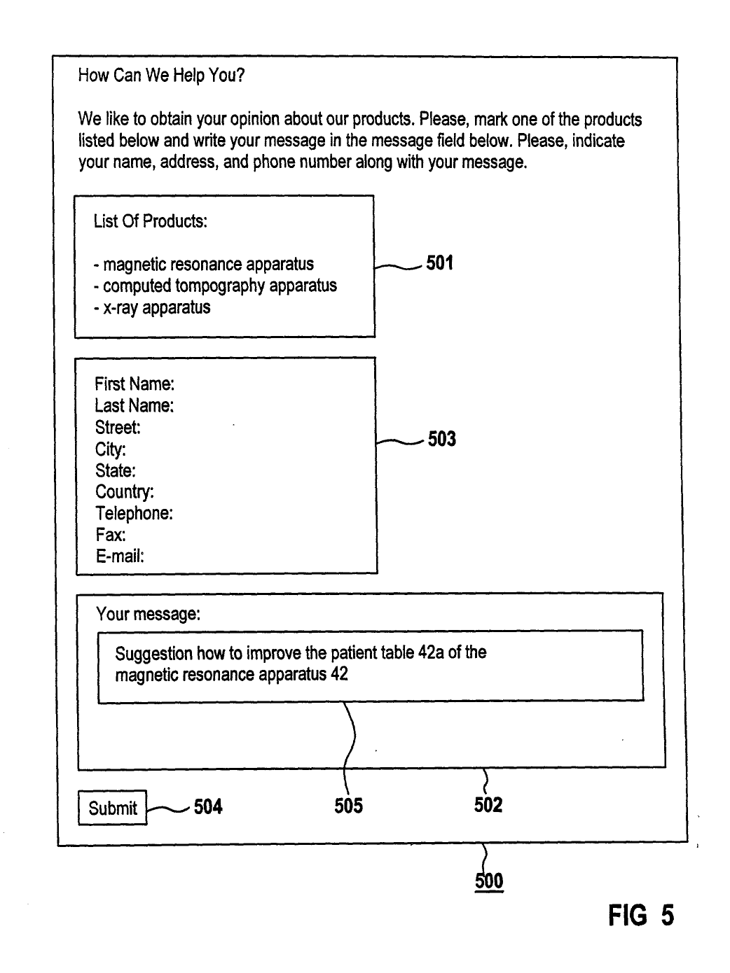

The web page 400 includes among other things, information about current products offered by the manufacturer. The web page 400 comprises further a button 401 which is titled “tell us”. The button 401 points when activated to an electronic form 500 which is depicted in FIG. 5. The button 401 can be activated by hitting it using, for example, the mouse of computer 40.

In the present example, the customer 41 activates the “tell us” button 401 and the electronic form 500 appears on the screen of his computer 40 (step B of the flow chart of FIG. 6).

The electronic form 500 is comprised of a list of products 501, a message field 502, a field 503 in which the customer 41 can indicate his return address and his e-mail address, and a “submit” button 504.

The products on the list of products 501 are the type of products offered by the manufacturer. Since the manufacturer sells medical apparatuses and particularly the magnetic resonance apparatus 35, the computed tomography apparatus 34, and the x-ray apparatus 33, the list of products 501 includes a magnetic resonance apparatus, a computed tomography apparatus, and an x-ray apparatus. The list of products 501 is further designed so that the customer 41 can mark one of the products with the mouse of his PC 40.

In the present example, the customer 41 wants to submit to the manufacturer a message 505 about how to improve the magnetic resonance apparatus 42 and especially its patient table 42a. Therefore, the customer marks the term “magnetic resonance apparatus” on the list of products 501 with his mouse, writes his or her return address and his e-mail address in the field 503, and writes a message 505 in the message field 502, i.e. the customer fills out the electronic form 500 (step C of the flow chart of FIG. 6).

After the customer fills out the electronic form 500, the customer hits the “submit” button 504 to send the message 505 to the manufacturer.

Upon hitting the “submit” button 504 the filled out electronic form 500 is automatically sent to a predefined e-mail address assigned to the manufacturer and to the computer-server 30 and forwarded to the database 36 (step D of the flow chart of FIG. 6).

The database 36 is configured so that it extracts the message of an incoming filled out electronic form. The database 36 is further configured to store extracted messages which are related to an x-ray apparatus on table 37a, extracted messages which are related to a computed tomography apparatus on table 37b, and extracted messages which are related to a magnetic resonance apparatus on table 37c.

Since the term “magnetic resonance apparatus” is marked on the filled out electronic form 500, the database 36 has information available about which product the message 505 is regarding. As a result, the database 36 extracts the message 505 from the filled out electronic form 500 and stores it on table 37c of the database 36 (step E of the flow chart of FIG. 6).

Table 37c contains further messages which have further suggestions for improvement of magnetic resonance apparatuses. These messages have been sent by other customers (not shown in FIG. 3) of the manufacturer. There are also messages stored on tables 37a and 37b. These messages are related to x-ray (table 37a) and to computed tomography apparatuses (table 37b) and have been sent by customers (not shown in FIG. 3) of the manufacturer.

The computer-server 30 is further connected to a monitor 50, so that an employee 51 of the manufacturer can view the tables 37a to 37c. Since the messages stored on the tables 37a to 37c are ordered according to the products offered by the manufacturer, the employee 51 can scan suggestions for improvements of a certain product in a relatively short time.

The database 36 is further configured to scan each message, which is added to one of the tables 37a to 37c, for predefined terms. In the case of the present exemplary embodiment, the predefined terms are related to components of the products offered by the manufacturer. For example, if an added message is related to a magnetic resonance apparatus, the new message is stored on table 37c like the message 505, then those predefined terms are related to specific components of a magnetic resonance apparatus. Components of a magnetic resonance apparatus are, for instance, a patient table, a basic field magnet, a gradient field magnet, a display, a control device, or an imagine-software of the magnetic resonance apparatus 35. Predefined terms for which a message stored on table 37c are scanned comprise, according to the present exemplary embodiment, “patient table”, “gradient coil”, “basic field”, “high frequency system”, “display device”, “control device”, and “imagine software”. After a newly stored message has been scanned, it is, depending on found terms, copied and forwarded to a database 60 which is associated with the product development department of the manufacturer. The forwarded message is then stored on a table from tables 61 of the database 60. Each table of the tables 61 is related to one of the predefined terms. Additionally, the database 60 is connected to a screen 62. Therefore, an employee 63 who works in the product development department can easily view those messages which are related to a specific component of the certain product he currently wants to improve.

In the present example, the message 505 is scanned for the mentioned above predefined terms as soon as it is stored on table 37c (step F of the flow chart of FIG. 6). Since the message 505 includes a suggestion to improve the patient table 42a of the magnetic resonance apparatus 42, the message 505 is copied and forwarded to the database 60 (step G of the flow chart of FIG. 6). Should the employee 63 be currently assigned to improve the patient table of the manufacturer's magnetic resonance apparatus 35, the employee 63 then can read this message 505 by contacting the database 60 and opening the appropriate table of tables 61.

In the present exemplary embodiment of the invention, each incoming electronic form is also scanned to determine if it has been submitted by a customer of the manufacturer or by somebody else. Should an electronic form be submitted by a customer, then the respective message is copied and forwarded to a database 70, after the message is stored on the database 36. The database 70 is operated by the manufacturer's marketing department. Each of the tables 71 of the database 70 is assigned to a specific customer. Furthermore, the database 71 is connected to a screen 72 so that an employee 73 who works for the marketing department can view the database 70. Since each table of the tables 71 is assigned to a specific customer, the employee 73 can inform himself in a relatively short time whether a certain customer submits relatively many suggestions. Therefore, the employee 73 can react appropriately to the individual suggestions of an individual customer.

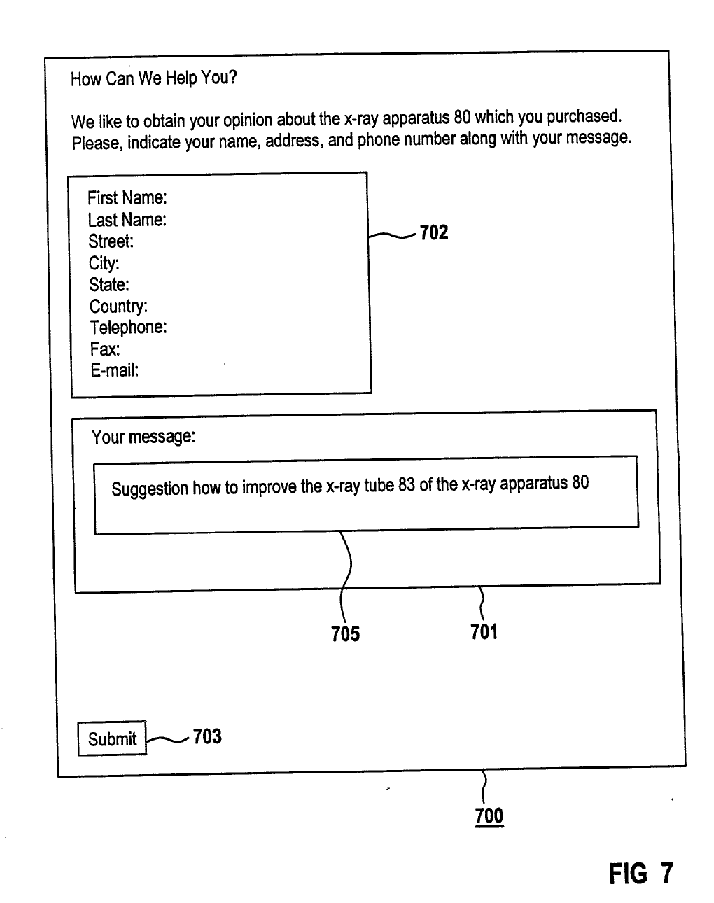

In addition, FIG. 3 shows an x-ray apparatus 80 which a customer 82 purchased from the manufacturer. The x-ray apparatus 80 is controlled by a computer 81 which is connected to the Internet 31. The computer 81 controls the x-ray apparatus 80 with a software stored on the computer 81 in a way commonly known in the art. The computer 81 is further configured in such a way that it comprises an electronic form 700 which is shown in FIG. 7. The electronic form 700 is available as soon as the computer 81 is appropriately configured and can be viewed on the screen of the computer 81.

The electronic form 700 has a message field 701, a field 702 in which the customer 82 can indicate a return address and an e-mail address, and a “submit” button 703.

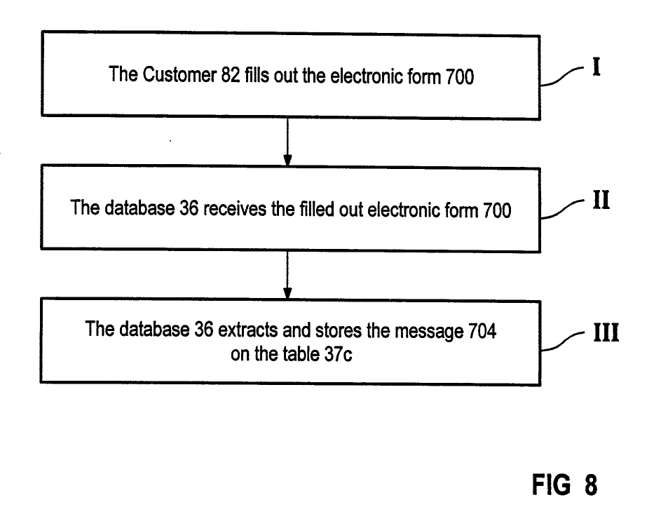

In the present example, the customer 82 wants to submit a suggestion about how the manufacturer can improve the x-ray apparatus 80 and especially its x-ray tube 83. Therefore, the customer 82 writes a message 704 in the message field 703. The message 705 includes the customer's suggestion to the manufacturer on how to improve the x-ray tube 83 of the x-ray apparatus 80. The customer 82 indicates further a return address and an e-mail address in the field 702 (step I of the flow chart of FIG. 8).

Moreover, the computer 81 is configured so that the electronic form 700 is automatically sent to the e-mail address assigned to the manufacturer and the computer-server 30 as soon as the customer 82 hits the “submit” button 703. Thus, the database 36 receives the filled out electronic form 700 after the customer 82 hits the “submit” button (step II of the flow chart of FIG. 8).

Since the electronic form 700 was submitted from the computer 81 and the computer 81 is part of the x-ray apparatus 80, the database 36 obtains information that the message 704 is associated with an x-ray apparatus. Consequently, the database 36 extracts and stores the message 704 on table 37a of the database 36 (step III of the flow chart of FIG. 8).

After the message 704 has been stored on table 37a, it is scanned for predefined terms related to the x-ray apparatus 33. These terms are related to components of the x-ray apparatus 33. Some of the predefined terms for the present example are “x-ray”, “detector”, and “software”.

Depending on found terms, the message 704 is copied and forwarded to the database 60 of the product development department.

As was already described above, each incoming electronic form is additionally checked to discover, if it was submitted by one of the manufacturer's customers. Since the electronic form 700 was submitted by the customer 82, the message 704 is copied and forwarded to the database 70 of the marketing department.

Although modifications and changes may be suggested by those skilled in the art, it is the intention of the inventor to embody within the patent warranted hereon all changes and modifications as reasonably and properly come within the scope of her contribution to the art.

I claim as my invention:

1. A computerized method for obtaining and processing messages for improving a product comprising the steps of:
a) receiving, at a central database, an electronic form which has been filled out so that it contains a message and information which identifies said product for which an improvement is suggested,
b) retrieving said message from said electronic form, and
c) based on said information, storing said message in a table of said central database, said table being related to said product.

2. The computerized method of claim 1 further comprising the steps of:
obtaining said electronic form through a web page, said web page having a link to said central database, said electronic form having a message field, a list of products, and a submit function;
making said electronic form when activating said link; and
writing said message in said message field, marking one of said products of said list of products can be marked, said marked product relates to said product to be improved, and automatically submitting said electronic form to said central database when said message is written in said message field, said product is marked, and said submit function is activated.

3. The computerized method of claim 1, wherein said product is a computer-software product which includes said electronic form, said method comprising the further steps of:
including said electronic form available when said computer-software is configured on a computer, said electronic form having a message field and a submit function;
writing said message in said message field; and
automatically directing said electronic form to said central databank when said submit function is activated and said computer is connected to an information network.

4. The computerized method of claim 1, further comprising, after storing said message in said table, scanning said message for predefined terms and, according to terms found in said scanning, forwarding said message to a predefined address.

5. The computerized method of claim 4, comprising predefining said address to be an address related to a marketing department of a manufacturer of said product.

6. The computerized method of claim 4, comprising predefining said address to be an address related to a product development department of a manufacturer of said product.

7. The computerized method of claim 2, comprising adapting said list of products to a person who downloads said Web page.

8. A system comprising of:
an electronic form having a message field, a list of products, a submit function;
a central database which contains tables respectively related to products in said list of products;
said electronic form being obtainable through a web page which can be downloaded with a computer connected to the Internet;
said electronic form being filled out by writing a message via said computer in said message field and by marking one of the products of said list of products;
said electronic form which is filled out being conveyed to said central database by activating said submit function; and
said central database storing said message based on the marked product in a table of said tables related to said marked product.

9. The system of claim 8, wherein said central database comprises a scanner which scans said message for predefined terms and forwards said message to a predefined address according to terms found in scanning said message.

10. The system of claim 9, wherein said address is related to a marketing department of a manufacturer of said product.

11. The system of claim 9, wherein said address is related to a product development department of a manufacturer of said product.

12. The system of claim 8, wherein said computer adapts said list of products according to a person who downloads said Web page.

13. A computerized method for obtaining and processing messages for improving a work routine comprising the steps of:
a) receiving, at a central database, an electronic form which has been filled out so that it contains a message and information which identifies said work routine for which an improvement is suggested,
b) retrieving said message from said electronic form, and
c) based on said information, storing said message in a table of said central database, said table being related to said work routine.

14. The computerized method of claim 13 further comprising the steps of:
obtaining said electronic form through a web page, said web page having a link to said central database, said electronic form having a message field, a list of work routines, and a submit function;
making said electronic form when activating said link; and
writing said message in said message field, marking one of said products of said list of products can be marked, said marked work routine relates to said product to be improved, and automatically submitting said electronic form to said central database when said message is written in said message field, said work routine is marked, and said submit function is activated.

15. The computerized method of claim 13, wherein said work routine is related to a computer-software product which includes said electronic form, said method comprising the further steps of:
including said electronic form available when said computer-software is configured on a computer, said electronic form having a message field and a submit function;
writing said message in said message field; and
automatically directing said electronic form to said central databank when said submit function is activated and said computer is connected to an information network.

16. The computerized method of claim 13, further comprising, after storing said message in said table, scanning said message for predefined terms and, according to terms found in said scanning, forwarding said message to a predefined address.

17. The computerized method of claim 13, comprising adapting said list of products to a person who downloads said Web page.

18. A system comprising of:
an electronic form having a message field, a list of products, a submit function;
a central database which contains tables respectively related to work routines in said list of work routines;
said electronic form being obtainable through a web page which can be downloaded with a computer connected to the Internet;
said electronic form being filled out by writing a message via said computer in said message field and by marking one of the work routines of said list of work routines;
said electronic form which is filled out being conveyed to said central database by activating said submit function; and
said central database storing said message based on the marked product in a table of said tables related to said marked product.

19. The system of claim 18, wherein said central database comprises a scanner which scans said message for predefined terms and forwards said message to a predefined address according to terms found in scanning said message.

20. The system of claim 18, wherein said computer adapts said list of products according to a person who downloads said Web page.
